(19) United States
(12) Patent Application Publication
(10) Pub. No.: US 2004/0149921 A1
(43) Pub. Date: Aug. 5, 2004

(54) Personal solar adviser

(76) Inventor: Alexander Smyk, Washington, DC (US)

Correspondence Address: McDERMOTT, WILL & EMERY, 600 13th Street, N.W., Washington, DC, 20005-3096, US

(21) Appl. No.: 10/358,218

(22) Filed: Feb. 5, 2003

(51) Int. Cl. G01J 1/42

(52) U.S. Cl. 250/372

(57) ABSTRACT

A system for advising a person of a desirable UV radiation dosage level is provided with a sensor mechanism for determining person's individual characteristics affecting UV radiation exposure. In response to the determined person's individual characteristics and additional factors affecting person's UV radiation exposure, a data processing mechanism determines a level of UV radiation dosage desirable for the person. A radiation detection mechanism detects dosage of UV radiation affecting the person, and an indication mechanism indicates when the detected UV radiation dosage reaches the desirable level or whether the detected UV radiation dosage is below a level necessary for the person to achieve health benefits associated with UV radiation exposure.

### FIELD OF THE INVENTION

The present invention relates to monitoring exposure to ultraviolet (UV) radiation, and more specifically, to a method and system for warning a user when UV radiation dosage reaches an acceptable level determined based on multiple factors affecting user's exposure to UV radiation, or does not reach a level necessary for the user to achieve health benefits associated with UV exposure.

### BACKGROUND ART

Moderate sunlight exposure can provide an individual with substantial health benefits, such as increased resistance to infection, increased stress tolerance, reduced blood cholesterol, increased muscular strength, etc. For example, sunlight rays are beneficial in the production of vitamin D in the skin. Sunlight exposure can increase the absorption of calcium in the intestine to maintain calcium balance even with low amounts of calcium in the diet.

However, excessive UV radiation may adversely affects human skin, and cause such adverse effects as sunburn. Chronic exposure to intense UV radiation can be associated with premature aging of the skin, DNA damage and an increased risk of skin cancer and other diseases.

Sunlight includes two types of rays—UVA rays with a wavelength of 315 to 400 nanometers, and UVB rays with a wavelength of 280 to 315 nanometers. The UVB rays are the sun's burning rays (which are blocked by window glass) and are the primary cause of sunburn and skin cancer. UVA rays (which pass through window glass) penetrate deeper into the dermis, or base layer of the skin. They also contribute to skin burning and skin cancer. In addition, both UVA and UVB rays can cause suppression of the immune system.

Hence, care is needed to obtain adequate exposure to sunlight, while avoiding excessive exposure. Several types of UV radiation detectors have been developed to monitor exposure to UV radiation, including personal dosimeters for detecting harmful UV radiation dosage.

However, existing UV dosimeters does not take into account many individual factors affecting sunlight exposure. Among such factors are type of the individual's skin, whether the individual's skin is untanned or already tanned, the age and sex of the individual, the sun protection factor (SPF) of a sun protection substance used by the individual, a portion of individual's body exposed to UV radiation, season of year, time of the day, latitude, humidity, etc.

For example, the Food and Drug Administration, and the American Academy of Dermatology recognize six skin categories. Skin type 1 relates to extremely sun sensitive skin that burns easily and never tans. Red-headed people may have this type of skin. Skin type 2 corresponds to very sun sensitive skin that burns easily and tans minimally. Fair-skinned, fair-haired, blue-eyed Caucasians may be an example of this skin type. Skin of type 3 is average skin that sometimes burns and tans gradually to light brown. Skin of type 4 is minimally sun sensitive, burns minimally and always tans to moderate brown. Skin type 5 defines sun insensitive skin that rarely burns and tans well. Finally, skin of type 6 is sun insensitive, deeply pigmented skin than never burns.

While lighter skin is more sun sensitive, darker skin people typically have more problems with sunlight underexposure. In addition, lower sunlight exposures are required for vitamin D generation for lighter skin people. However, elderly people may need higher UV dosage to develop sufficient amount of vitamin D.

Further, untanned skin is more sensitive to sunlight than tanned skin. For example, sunlight exposure of people with untanned skin is associated with higher risk of melanoma than exposure of people with suntanned skin.

Another important factor affecting sunlight exposure is the SPF of a sun protection substance used by an individual, such as a sunscreen or sunblock. The SPF numbers on the packaging can range from as low as 2 to as high as 60. These numbers refer to the product's ability to screen or block out the sun's burning rays.

The need thus exists for a personal solar advisor that would warn an individual when UV radiation dosage reaches an acceptable level established based on multiple individual factors affecting sunlight exposure, or does not reach a minimum level necessary for the individual to achieve health benefits associated with UV exposure.

### DISCLOSURE OF THE INVENTION

The present invention fulfills this need by providing a system for monitoring exposure of a person to UV radiation. The system comprises a data processing circuit for determining a desirable level of UV radiation dosage based on factors affecting the person's exposure, and an indication circuit responsive to the determined desirable level for indicating when the UV radiation dosage reaches an acceptable level established based on multiple individual factors affecting sunlight exposure.

Alternatively, the indication circuit may be configured to further indicate if the detected UV radiation dosage level does not reach a minimum level necessary for the individual to achieve health benefits of UV exposure. This minimum level may be determined based on individual factors affecting user's UV radiation exposure.

In accordance with one aspect of the present invention, the data processing circuit is configured for determining a level of UV radiation dosage based on person's individual characteristics, such as colors of untanned skin and tanned skin. Further, the data processing circuit may be configured to adjust the determined level based on various desired factors to establish the desirable level of UV radiation dosage.

In particular, the data processing circuit may adjust the determined level based on a desired mode of UV exposure selected by a user. For example, the system may accommodate user's UV exposure in intensive, moderate and safe modes. Further, the data processing circuit may adjust the acceptable level based on a sun protection factor of a sun protection substance used by the person, and multiple other factors affecting user's UV exposure.

In accordance with another aspect of the invention, the system may further comprise a sensor mechanism for determining person's individual characteristics affecting UV radiation exposure to establish a desirable level of UV radiation dosage, a radiation detection mechanism for detecting UV radiation dosage affecting the person, and an indication mechanism for indicating when the detected UV radiation dosage reaches the desirable level or whether it reaches that level.

In accordance with an embodiment of the present invention, the sensor mechanism may be configured to determine colors of person's untanned skin and tanned skin. The sensor mechanism may comprise a white light source illuminating a required portion of person's skin, and red, green and blue light sensors for determining color of the required portion of the skin. The color may be determined using a calorimetric process that takes into account not only relations between the red, green and blue colors but also their tone.

The data processing mechanism may include a look-up table for providing a value of UV radiation dosage acceptable for an individual based on colors of untanned and tanned skin portions of that individual. The radiation detection mechanism may include UVA and UVB sensors. The indication mechanism may include a sound generator for generating an alarm signal when the measured UV radiation dosage reaches the desirable level or does not reach a minimum level necessary for the individual to achieve health benefits of UV exposure, and/or a visual indicator for producing an alarm signal when the measured UV radiation dosage reaches the desirable level or does not reach the minimum necessary level.

In accordance with a method of the present invention, the following steps are carried out to monitor exposure of a person to sunlight:

determining person's individual characteristics to establish a UV radiation dosage level acceptable for the person, and

indicating when UV radiation dosage affecting the person reaches the acceptable level.

The step of determining person's individual characteristics may include the steps of determining color of person's untanned skin and determining color of person's suntanned skin.

The method of the present invention may further comprise the step of adjusting the acceptable level based on factors affecting sunlight exposure, before comparing the acceptable level with the UV radiation dosage.

Still other objects and advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is a diagram schematically illustrating a personal solar adviser of the present invention.

FIG. 2 is a flow chart illustrating operations of the personal solar adviser.

### DETAILED DESCRIPTION OF THE INVENTION

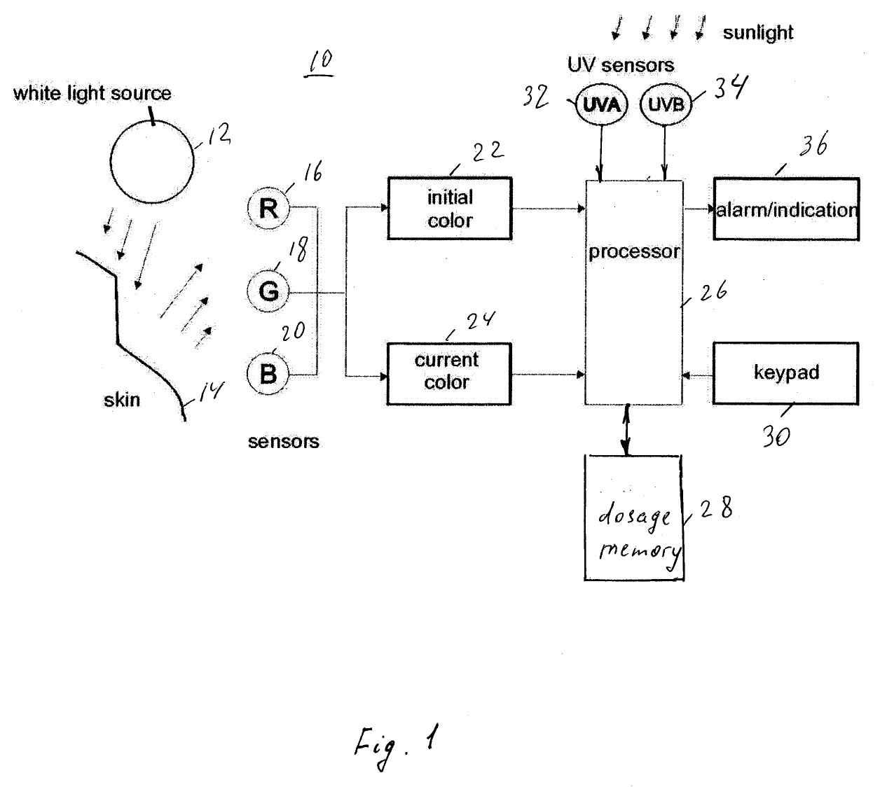

FIG. 1 schematically illustrates a personal solar advisor 10 of the present invention that provides indication when UV radiation dosage reaches a desired level established based on factors affecting user's exposure to solar radiation. The personal solar advisor 10 comprises a white-light source 12 for illuminating a required portion of user's skin 14. For example, a white-light light emitting diode (LED) may be used as the white-light source 12.

Red, green and blue light sensors 16, 18 and 20, respectively, are provided for determining color of the user's skin portion illuminated by the light source 12. Red, green and blue light sensors 16, 18 and 20 may be made of three Si-PIN photo diodes integrated on a chip. They may be arranged as 3 segments of a ring. Such circular alignment of the diodes provides equal angle of incidence at each sensor when the white-light source is arranged at the center of the ring.

In order to reduce cross talk between the photodiodes, the individual sectors may be separated from each other. Each of these photo diodes is associated with dielectric spectral filter for sensing primary colors—red, green and blue. The filters may be mounted directly on the photodiodes to reduce the size of the color sensing system.

An initial color input 22 and a current color input 24 provide a data processor 26 with data representing initial and current colors of the user's skin. As discussed in more detail later, the initial color is determined based on illumination of an untanned portion of the skin, whereas the current color is determined based on illumination of a suntanned portion of the skin.

The processor 26 interacts with a dosage memory 28 that stores an acceptable dosage look-up table containing experimentally determined maximum values of UV radiation dosage acceptable for people with various initial and current skin colors. In accordance with an alternative embodiment of the invention, the dosage memory 28 may also store a necessary level look-up table containing experimentally determined minimum values of UV radiation dosage necessary for people with various initial and current skin colors. In accordance with another alternative embodiment of the invention, instead of interacting with a look-up table, the processor 26 may calculate the acceptable and necessary values of UV radiation for people with various initial and current skin colors using a prescribed algorithm.

Initial and current skin colors may be represented by multiple grades in the range from the lightest skin color to the darkest skin color. For each combination of an initial skin color grade and a current skin color grade, the acceptable look-up table and/or necessary look-up table contain the pre-determined maximum acceptable or minimum necessary UV radiation dosage. Based on the initial skin color and the current skin color determined by the sensor 16, 18 and 20, the processor 26 accesses the look-up tables to determine the maximum acceptable and/or minimum necessary value of UV radiation dosage for a respective combination of the initial skin color and the current skin color.

A key pad 30 is provided for supplying the processor 26 with data representing multiple factors affecting solar radiation exposure, such as a mode of exposure, sun protection factor (SPF) of a sun protection substance used by a person exposed to the solar radiation, age and sex of this person, portion of the body exposed to UV radiation, season of year, time of the day, latitude, humidity, etc. As discussed in more detail below, these data are used by the processor 26 for adjusting the UV dosage value provided by the look-up tables or calculated using the prescribed algorithm to determine desirable UV dosage.

The key pad 30 contains a number of keys for entering data and selecting modes of operation. In particular, the key pad 30 may contain a key for on/off switching of the personal solar advisor 10, and keys enabling a user to operate in at least three modes of solar radiation exposure: intensive mode, moderate mode and safe mode. In a manner well know to those skilled in the art, the processor 26 may interact with program and data memories, which may be implemented as ROM and RAM (not shown).

UVA sensor 32 and UVB sensor 34 are arranged for providing the processor 26 with data representing UV radiation. The UVA sensor 32 determines UVA radiation with a wavelength in the range from 315 to 400 nanometers, whereas the UVB sensor 32 detects UVB radiation with a wavelength in the range from 280 to 315 nanometers. The UVB rays are beneficial in the production of vitamin D. However, they are the primary cause of sunburn and skin cancer. UVA rays penetrate deeper into the dermis, or base layer of the skin.

The processor 26 determines integral UV radiation dosage resulted from UV radiation detected by the sensors 32 and 34, and compares this dosage with the desirable UV dosage. An alarm/indicator 36 may contain a liquid crystal display (LCD) indicator and a sound generator to provide visual and/or audio indication when the dosage of UV radiation affecting the user reaches a level of the desirable UV dosage. In addition, the LCD indicator may be used to display step-by-step instructions assisting the user in setting the desirable UV radiation dosage.

The personal solar advisor 10 may be implemented as an integral device resembling such gadgets as a wristwatch, sunglasses, a pendant, a brooch or any other gadget that may be carried or worn on a beach.

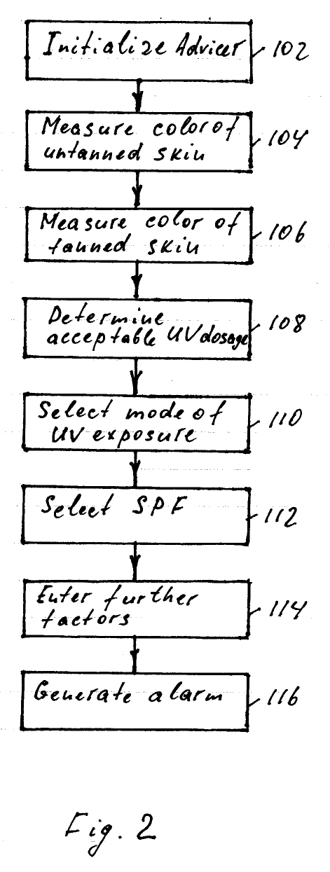

Referring to FIG. 2, operation of the personal solar advisor 10 may be initiated by pressing an on/off key on the keypad 30 (block 102). A significant aspect of the present invention is utilizing colors of untanned and tanned portions of person's skin to evaluate acceptable dosage of solar radiation for that person.

In accordance with an embodiment of the present invention, white light produced by the white-light source 12 is directed to an untanned skin portion of a solar adviser's user. The red, green and blue sensors 16, 18 and 20 detect the light reflected from the skin in three color ranges: red, green and blue (block 104).

The light sensors 16, 18 and 20 may be made of photo diodes that produce red, green and blue photocurrents I_{red}, I_{green}, and I_{blue}, respectively, corresponding to the detected light in respective color ranges. A three-channel transimpedance amplifier may be used to convert the photocurrents into corresponding voltage values. Then, an analog-to-digital (A/D) converter may be utilized to digitize the voltage values. Hence, the color sensing system of the present invention requires only three measured values—red, green and blue to detect the color of the skin. These values are detected simultaneously for determining the color. As a result, the low-cost and fast signal processing may be achieved. Direct mounting of the spectral filters onto the photodiodes allows the size of the color sensing system of the present application to be substantially smaller than the size of traditional color measuring instruments.

Similar to human's eye, the 3-element color sensing system of the present invention uses three spectral ranges for recognizing the skin color. Via the initial color input 22, the red, green and blue color values representing the initial natural color of the user are supplied to the processor 26.

Although the 3-element color sensing system is disclosed in the exemplary embodiment of the present invention, other known system, such as integral color sensors, row color sensors or hexagonal color sensors, also may be utilized for detecting skin color in accordance with the present invention.

In addition to the initial skin color represented by an untanned portion of the user's skin, the personal solar adviser 10 of the present invention detects the current color of the user's skin represented by a tanned portion of the skin. In particular, a tanned portion of the user's skin is illuminated with the white-light source 12. Similar to the initial skin color measurement, the color sensors 16, 18 and 20 detect the light reflected from the tanned portion and produce the respective photocurrents converted into three voltage values representing the current color of the user's skin in three color ranges—red, green and blue (block 106). Via the current color input 24, the color values representing the current skin color are supplied to the processor 26. Any known color recognition program may be utilized by the processor 26 to determine initial and current colors of the user's skin based on read, green and blue color values for each measured color.

The processor 26 uses a combination of the determined initial and current colors of the user's skin as a pointer to a location in the acceptable dosage look-up table that contains maximum value of UV radiation dosage acceptable for people having the determined combination of initial and current skin colors (block 108). As discussed above, the look-up table stores experimentally determined maximum values of UV radiation dosage acceptable for people with various initial and current skin colors represented by multiple grades in the range from the lightest color skin to the darkest color skin. For each combination of an initial skin color grade and a current skin color grade, the acceptable dosage look-up table contains a pre-determined maximum acceptable UV radiation dosage.

As discussed above, in addition to the acceptable dosage look-up table, the necessary dosage look-up table may be utilized to store minimum values of UV radiation necessary for the user to achieve health benefits of UV exposure. In this case, the processor 26 may use the determined initial and current colors of the user's skin to access the necessary look-up table in a way similar to disclose above.

After measuring the initial and current skin color, the user enters into the personal solar adviser 10 additional factors affecting UV radiation exposure. In particular, the key pad 30 may be used to select a desired mode of UV radiation exposure (block 110). For example, the personal solar adviser 10 may accommodate 3 modes of UV radiation exposure: intensive, moderate and safe. In the intensive mode, a user is exposed to the maximum acceptable UV radiation dosage. In this mode, the personal solar adviser warns a user when the detected UV radiation dosage reaches the maximum acceptable level determined by the processor 26 based on the acceptable dosage look-up table.

In the safe mode, the personal solar adviser 10 warns a user when the UV radiation dosage reaches a minimum harmful level that may be unsafe for the user. The minimum harmful level may be pre-programmed by the user. For example, it may be set at a level, which is 50% lower than the maximum acceptable level. In the moderate mode of UV radiation exposure, the personal solar adviser 10 warns a user when the UV radiation dosage reaches a level set in the middle of the range between the maximum acceptable level and the minimum harmful level.

Further, a user may enter into the personal solar adviser 10 a sun protection value representing, for example, a sun protection factor (SPF) of a sun protection substance utilized by the user (block 112). SPF values of sun protection substances can range from as low as 2 to as high as 60. These numbers refer to the product's ability to screen or block out the sun's burning rays. The sunscreen SPF rating is calculated by comparing the amount of time needed to produce a sunburn on protected skin to the amount of time needed to cause a sunburn on the unprotected skin. For example, if a sunscreen is rated SPF 2 and a fair-skinned person who would normally turn red after ten minutes of exposure in the sun uses it, it would take twenty minutes of exposure for the skin to turn red. A sunscreen with an SPF of 15 would allow that person to multiply that initial burning time by 15, which means it would take 15 times longer to burn, or 150 minutes.

Hence, based on the entered sun protection value, the processor 26 may increase a desired level of UV radiation dosage set for a particular mode of UV exposure compared to a dosage set for unprotected skin.

In addition, the key pad 30 may enable a user to enter further factors affecting UV radiation exposure, such as the age of the individual, season of year, time of the day, latitude, humidity, etc. (block 114). Based on pre-programmed algorithms, the processor 26 will adjust established levels of desired UV radiation dosage in accordance with these further factors.

The processor 26 determines integral UV radiation dosage resulted from UV radiation detected by the UVA and UVB sensors 32 and 34, and compares this dosage with the desirable UV dosage established for a particular mode of UV radiation exposure and adjusted based on the SPF and other factors affecting UV radiation exposure. When the detected UV radiation dosage reaches a level of the desirable UV dosage, the processor 26 produces a warning signal that activates the alarm/indicator 36 (block 116). In response to the warning signal, a visual and/or audio signal is generated to warn a user that the desired level of UV radiation is reached. Alternatively, as discussed above, the warning signal may be also used for warning the user that a necessary level of UV radiation is not reached.

Hence, the personal solar adviser of the present invention warns a user exposed to UV radiation when the UV radiation dosage reaches a level established based on multiple factors affecting the user's UV radiation exposure.

In this disclosure, there are shown and described only the preferred embodiments of the invention, but it is to be understood that the invention is capable of changes and modifications within the scope of the inventive concept as expressed herein. For example, instead of determining values of UV radiation using look-up tables, the values of UV radiation may be calculated using a prescribed algorithm. Further, as one skilled in the art would appreciate, the personal solar advisor of the present invention may take into account a UV radiation dosage received by the user a predetermined time interval before the current UV radiation exposure. For example, the processor may count the time elapsed since the previous UV radiation exposure, and take this time into account when a desired UV radiation dosage is being determined.

What is claimed is:

1. A system for monitoring exposure of a person to UV radiation, comprising:
a data processing circuit for determining a desirable level of UV radiation dosage based on factors affecting the person's exposure, and
an indication circuit responsive to the determined desirable level for indicating when dosage of UV radiation affecting the person reaches the desirable level.

2. The system of claim 1, wherein the data processing circuit is configured for determining an acceptable level of UV radiation dosage based on person's individual characteristics.

3. The system of claim 2, wherein the data processing circuit is configured for determining the acceptable level of UV radiation dosage based on person's skin color.

4. The system of claim 3, wherein the data processing circuit is configured for determining the acceptable level of UV radiation dosage based on color of person's untanned skin.

5. The system of claim 4, wherein the data processing circuit is further configured for determining the acceptable level of UV radiation dosage based on color of person's tanned skin

6. The system of claim 2, wherein the data processing circuit is configured to adjust the determined acceptable level of UV radiation dosage based on desired factors to establish the desirable level of UV radiation dosage.

7. The system of claim 6, wherein the data processing circuit is configured to adjust the determined acceptable level of UV radiation dosage based on a desired mode of UV exposure.

8. The system of claim 6, wherein the data processing circuit is configured to adjust the determined acceptable level of UV radiation dosage based on a sun protection factor of a sun protection substance used by the person.

9. The system of claim 1, wherein the data processing circuit is configured for determining a level of UV radiation dosage necessary for the person, and the indication circuit is configured to provide indication if the person's UV radiation dosage does not reach the necessary level.

10. A system for advising a person of a desirable UV radiation dosage level comprising:
a sensor mechanism for determining person's individual characteristics affecting UV radiation exposure,
a data processing mechanism responsive to the determined person's individual characteristics for determining UV radiation dosage level desirable for the person,
a radiation detection mechanism for detecting dosage of UV radiation affecting the person, and
an indication mechanism for indicating when the detected UV radiation dosage reaches the desirable UV radiation dosage level.

11. The system of claim 10, wherein the sensor mechanism is configured to determine color of person's untanned skin.

12. The system of claim 11, wherein the sensor mechanism is further configured to determine color of person's tanned skin.

13. The system of claim 12, wherein the data processing mechanism includes a look-up table for providing a value of UV radiation dosage acceptable for an individual based on colors of untanned and tanned skin portions of that individual.

14. The system of claim 10, wherein the sensor mechanism comprises a light source illuminating a required portion of person's skin.

15. The system of claim 10, wherein the sensor mechanism comprises red, green and blue light sensors for determining color of a required portion of person's skin.

16. The system of claim 10, wherein the radiation detection mechanism includes UVA and UVB sensors.

17. The system of claim 10, wherein the indication mechanism includes a sound generator for generating an alarm signal when the detected UV radiation dosage reaches the desirable level.

18. The system of claim 10, wherein the indication mechanism includes a visual indicator for producing an alarm signal when the detected UV radiation dosage reaches the desirable level.

19. The system of claim 10, wherein the data processing mechanism is responsive to the determined person's individual characteristics for determining a level of UV radiation dosage necessary for the person to achieve health benefits of UV radiation exposure, and the indication mechanism is configured for indicating if the detected UV radiation dosage does not reach the necessary level.

20. A method of monitoring exposure of a person to sunlight, comprising the steps of:
(a) determining person's individual characteristics to establish a UV radiation dosage level acceptable for the person, and
(b) indicating when dosage of UV radiation affecting the person reaches the acceptable dosage level.

21. The method of claim 20, wherein the step (a) includes the steps of:
determining color of person's untanned skin and determining color of person's tanned skin.

22. The method of claim 20, further comprising the step of adjusting the acceptable dosage level based on factors affecting UV radiation exposure, before comparing the acceptable dosage level with the dosage of UV radiation.

23. The method of claim 20, further comprising the steps of:
determining the person's individual characteristics to establish a necessary UV radiation dosage level needed for achieving health benefits of the exposure to sunlight, and
indicating if the dosage of UV radiation affecting the person does not reach the necessary level.
